(19) United States
(12) Patent Application Publication
(10) Pub. No.: US 2013/0056954 A1
(43) Pub. Date: Mar. 7, 2013

(54) SYSTEM AND METHOD FOR BICYCLIST CONSUMABLE ITEM DISPENSING

(71) Applicant: Alexander Arrow, Menlo Park, CA (US)

(72) Inventor: Alexander Arrow, Menlo Park, CA (US)

(21) Appl. No.: 13/538,909

(22) Filed: Jun. 29, 2012

Related U.S. Application Data
(60) Provisional application No. 61/504,065, filed on Jul. 1, 2011.
(60) Provisional application No. 61/618,301, filed on Mar. 30, 2012.

(51) Int. Cl. B62J 9/00

(52) U.S. Cl. 280/288.4

(57) ABSTRACT

Embodiments are described for assisting an athlete in obtaining consumables such as food and sunblock while racing on a bicycle without slowing down, endangering him/herself, or performing unhygienic acts. In one embodiment, a mechanical one-hand-operable food-dispensing container may be coupled to a cyclist's bicycle such that it may be easily reached, and the solid pieces of food dispensed easily palmed by the same hand that operates it while the cyclist is racing. In another embodiment, a one-hand-operable liquid-sunblock-dispensing pump may be coupled to a cyclist's aerobars, such that its plunger may be depressed by the cyclist's thumb and the palm of the same hand may be positioned to receive the expelled sunblock, enabling the racer to apply sunblock without slowing down or endangering him/herself.

### RELATED APPLICATION DATA

The present application claims the benefit under 35 U.S.C. §119 to U.S. Provisional Application Ser. Nos. 61/504,065 filed Jul. 1, 2011 and 61/529,690 filed Aug. 31, 2011. The foregoing applications are hereby incorporated by reference into the present application in their entirety.

### FIELD OF THE INVENTION

The present invention relates generally to container systems, and specifically to technologies for bicyclists to access consumable items with one-handed push-button operation of bicycle-mounted containers.

### BACKGROUND

Competitive athletic events that involve bicycle racing (triathlon, cycling, and outdoor mountain bike or criterion road bicycle racing) impose a timing urgency upon the bicycle rider that makes it difficult for him/her to address basic human consumption needs. Eating solid food, in particular, is difficult while riding a bicycle at high speeds, even though long-distance bicycle races are often won by the rider who can master this. This is because the first to the finish line is usually the cyclist who can best balance the need for consuming calories in the form of energy bars or high-calorie gels with the need for pedaling fast and keeping one's hands and head in a horizontal position to minimize wind resistance.

Some long-distance competitive riders will un-wrap consumable energy bars before a race begins and stick them to their metal or carbon bicycle frames so that they can grab off pieces of the sticky bars during the race, even though such practice is (a) unhygienic, and (b) dangerous at high speeds. Others will try to get through an entire 50- or even a 100-mile bicycle race consuming no calories during the ride except what they can drink through liquid energy drinks in bicycle-mounted water bottles (FIG. 1A-1B; elements 2, 4) or other elaborate drinking-while-pedaling devices (FIG. 2A-2C; elements 6, 8, 10, 12). If a cycling race is held outdoors on a sunny day (as most are) the cyclist is also faced with a need to apply sunblock during the event that cannot be adequately addressed by pre-race sunblock application (especially if the event is a triathlon, in which case the sunblock will be washed away during the swimming portion of the race). Applying sunblock is as difficult or even more difficult than eating solid food while pedaling quickly and holding a bicycle's handlebars, because it involves using both hands to open a tube of sunblock and apply it to one's shoulders, arms, and/or face. To address the risk on sunburn on a 50- or 100-mile outdoor bicycle race, some athletes use small bike-mounted containers to store small tubes of sunblock, and to avoid severe sunburn they sacrifice speed during a race by stopping so they can take both hands off their handlebars and apply sunblock to their shoulders (66, 72), arms, face, and exposed portions of their back (68). Other athletes will resort to wearing long-sleeve bicycle jerseys, although this is a competitive disadvantage because a competing cyclist wearing less clothing will be less likely to feel overheated, will sweat less, and therefore be able to pedal faster.

Examples of methods used today for solid food dispensing during the bicycle portion of a triathlon include taking Powerbar® energy bars out of their wrappers (FIGS. 3A-B; wrappers are shown as element 16; bar portions are shown as elements 14 and 18) and cutting pieces (FIG. 3C; element 14) or even biting off pieces (FIG. 3D) and expelling them so they can be stuck to the horizontal top tube (22) of a bicycle. The size of each piece is chosen by the athlete competitor before the start of the race to be about the right size for one swallow of solid food appropriate for caloric intake during a high-speed race. Energy bar manufacturers have begun offering some energy bars in bite-size portions (FIGS. 4A-C; element 20) which has facilitated this practice. For example, referring to FIG. 5, a bicycle top-tube (22) with edible Powerbar® Energy Blasts® and Cliff® Shot Blocks® Electrolyte Chews stuck to it (24) is shown.

FIGS. 6A-C show attachable compartments (28,34), such as those available under the tradenames Bento Box® and Fuel Belt®, that athletes use today to hold both energy bars in their foil wrappers (as shown, for example, in FIG. 3A) and tubes of sunblock (FIG. 7; element 42) with screw-off or flip-top caps (44) that are coupled to the horizontal top tubes of a bike frame (22) using one or more sets of straps (30,36,40).

The challenge with such configurations is that both the cyclist's hands are needed to operate the attachable compartment, to un-wrap the wrapper of an energy bar, to un-screw or flip the cap of a tube of sunblock. Dispensing the sunblock also involves squeezing the tube (42) of sunblock with one hand while holding the other hand out to receive the sunblock and apply it to one's skin. Trying to un-wrap an energy bar with one hand or operate a tube of sunblock with one hand while operating a bicycle at high speeds in a bicycle race is dangerous.

While there are conventional technologies for facilitating one-handed dispensing, such as those illustrated in FIGS. 8-13, none are currently adapted to be mounted or coupled to a moving triathlete or other structures that may accompany the athlete, such as a bicycle. For example, referring to FIGS. 8-12, various conventional one-hand operation item-dispensing platforms in use in other applications provide some level of one-handed consumable dispensing, but as available, are not well suited for a triathlon. FIGS. 8A and 8B depict a conventional hand-operated candy dispenser with a handle (126) and a movable head portion for dispensing (130) small food elements such as candies (132). FIG. 9 depicts a countertop dispenser (134) with a reservoir (136) and a dispensing command lever (138). FIG. 10 depicts a toothpick (140) dispenser (142). FIG. 11 depicts a conventional drink (148) dispenser (146) with a dispensing lever (144). FIG. 12 depicts a system (150, 152) for dispensing food to a caged animal. Similarly, conventional one-handed-operation pump (154) containers (156) such as that depicted in FIG. 13 are also highly impractical to be taken along on a triathlon or similar athletic event.

There is a need for more convenient and less dangerous bicycle-mounted container system that dispenses solid energy bar pieces with one-hand operation. There is a similar need for more convenient and less dangerous bicycle-mounted container system that dispenses liquid sunblock with one-hand operation.

### BRIEF DESCRIPTION OF THE DRAWINGS

FIGS. 1A-1B illustrate conventional bicycle-mounted drinking containers.

FIGS. 2A-2B illustrate specialized bicycle racing drinking and liquid nutrition containers designed to allow the cyclist to continue at full racing speed while drinking.

FIGS. 3A-3D illustrate Powerbar® energy bars in their wrappers and unwrapped in preparation for being un-hygienically adhered to the horizontal top tube of a bicycle to be consumed by the cyclist while racing.

FIGS. 4A-4C illustrate recently-developed energy bar products featuring small pieces to facilitate consumption by bicycle racers while racing, although their packaging all requires two-hand operation.

FIG. 5 illustrates Powerbar® Energy Gel Blasts® and Cliff® Shot Blocks Electrolyte Chews® un-hygienically adhered to the horizontal top tube of a triathlon racing bicycle.

FIGS. 6A-C illustrate containers in use today to store solid food and sunblock containers for consumption while riding a bicycle.

FIG. 7 illustrates a standard tube of sunblock, which requires two-hand operation to use.

FIGS. 8A-B illustrates Pez® dispensers, which feature one-hand-operation solid food dispensing, in use today in an application unrelated to the field of bicycle racing.

FIG. 9 illustrates a one-hand-operation plastic fork dispenser, in use today in an application unrelated to the field of bicycle racing.

FIG. 10 illustrates a one-hand-operation toothpick dispenser, in use today in an application unrelated to the field of bicycle racing.

FIG. 11 illustrates a one-hand-operation drink-dispensing machine, in use today in an application unrelated to the field of bicycle racing.

FIG. 12 illustrates a gerbil, hamster, or laboratory rat feed pellet dispensing system, which a gerbil, hamster, or laboratory rat can operate with a single press of a trigger bar.

FIG. 13 illustrates a pump-operated plastic container of liquid sunblock.

FIG. 14A illustrates one embodiment of a solid food container dispensing system featuring a one-hand operation in accordance with the present invention, while FIGS. 14B-C illustrate the most likely positioning of the embodiment of the present invention on a racing bicycle, attached to the front portion of the horizontal top tube.

FIGS. 15A-B illustrate the racing position that a cyclist assumes during a bicycle race or during the bicycle portion of a triathlon. In both urban (FIG. 15A) and rural (FIG. 15B) races, large portions of the racers shoulders, lower back, and typically all of his/her arms are exposed and therefore vulnerable to severe sunburn.

FIGS. 16-18 illustrate one embodiment of a solid food container dispensing system featuring a one-hand operation in accordance with the present invention.

FIG. 19 illustrates the concept of multiple food-containing compartments in a container system.

FIGS. 20-23 illustrate one embodiment of a liquid sunblock container dispensing system featuring a one-hand operation in accordance with the present invention.

FIG. 24 illustrates one embodiment of a solid food one-hand-operation dispensing system configuration in accordance with the present invention.

FIG. 25 illustrates one embodiment of a liquid sunblock one-hand-operation dispensing system configuration in accordance with the present invention.

FIGS. 26A-26W illustrate various aspects of one embodiment of a food dispensing configuration with a rotatable member.

FIGS. 27A-27D illustrate various aspects of another embodiment of a food dispensing configuration with a rotatable member.

FIG. 28 illustrates an aerodynamic one-hand-operation liquid dispensing configuration which may be utilized for sunblock dispensing as mounted to a bicycle frame.

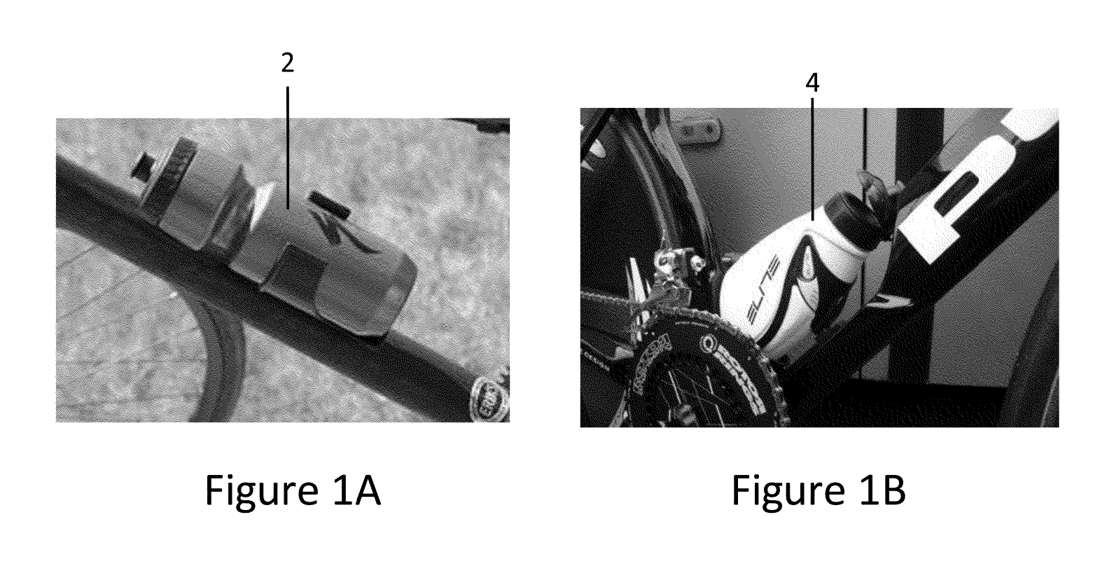

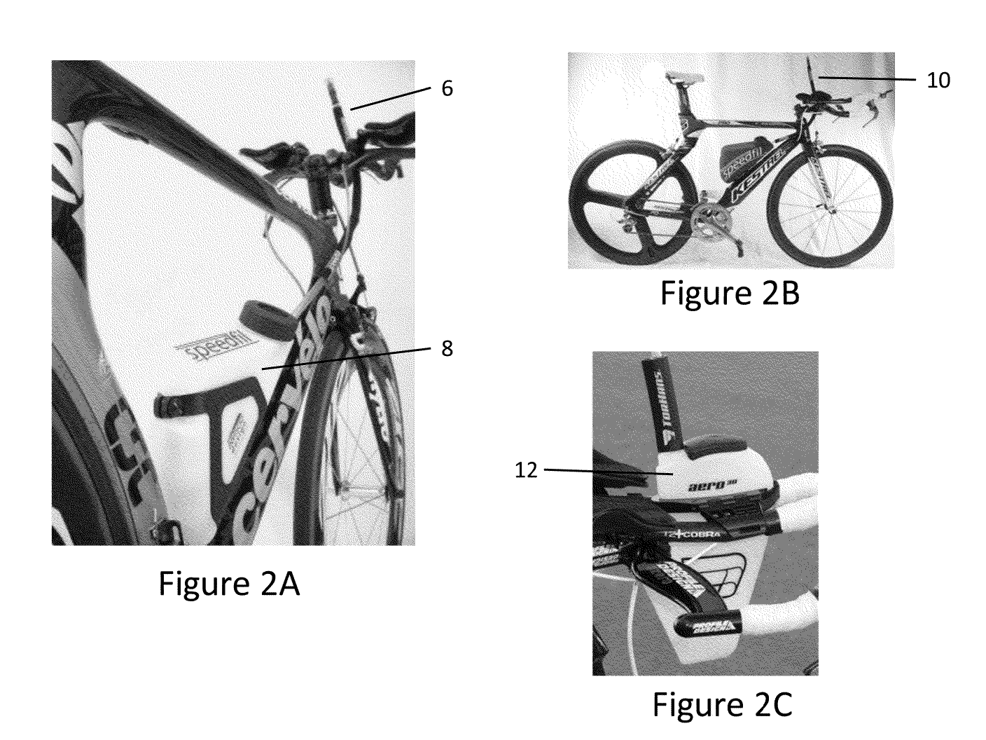

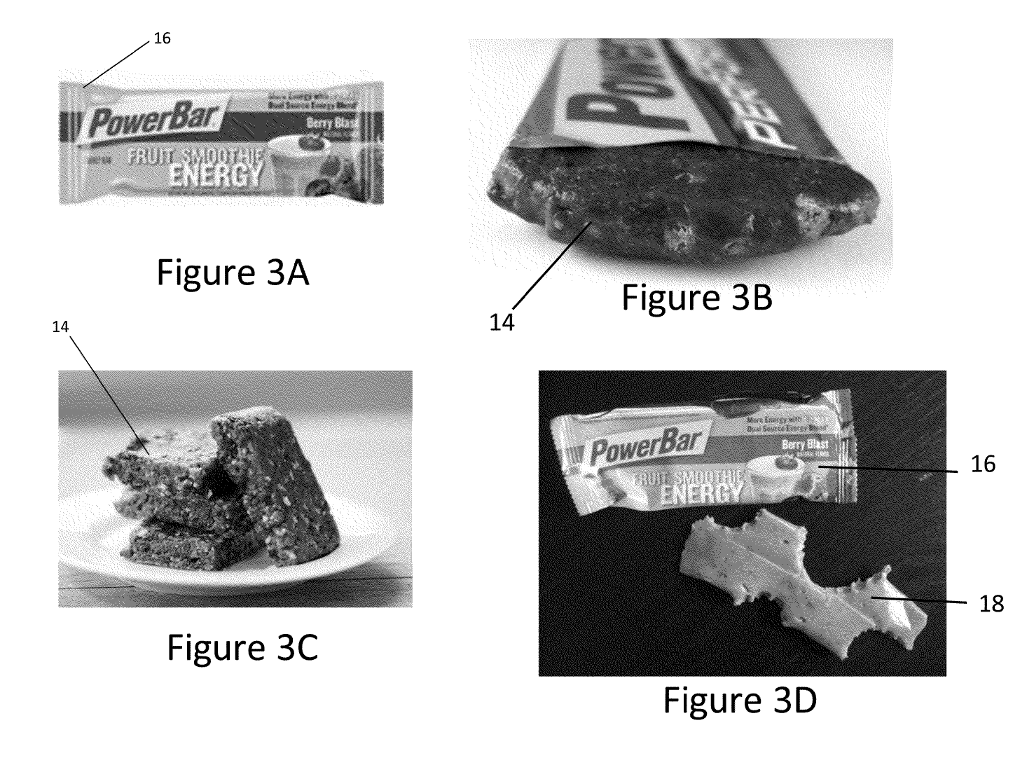

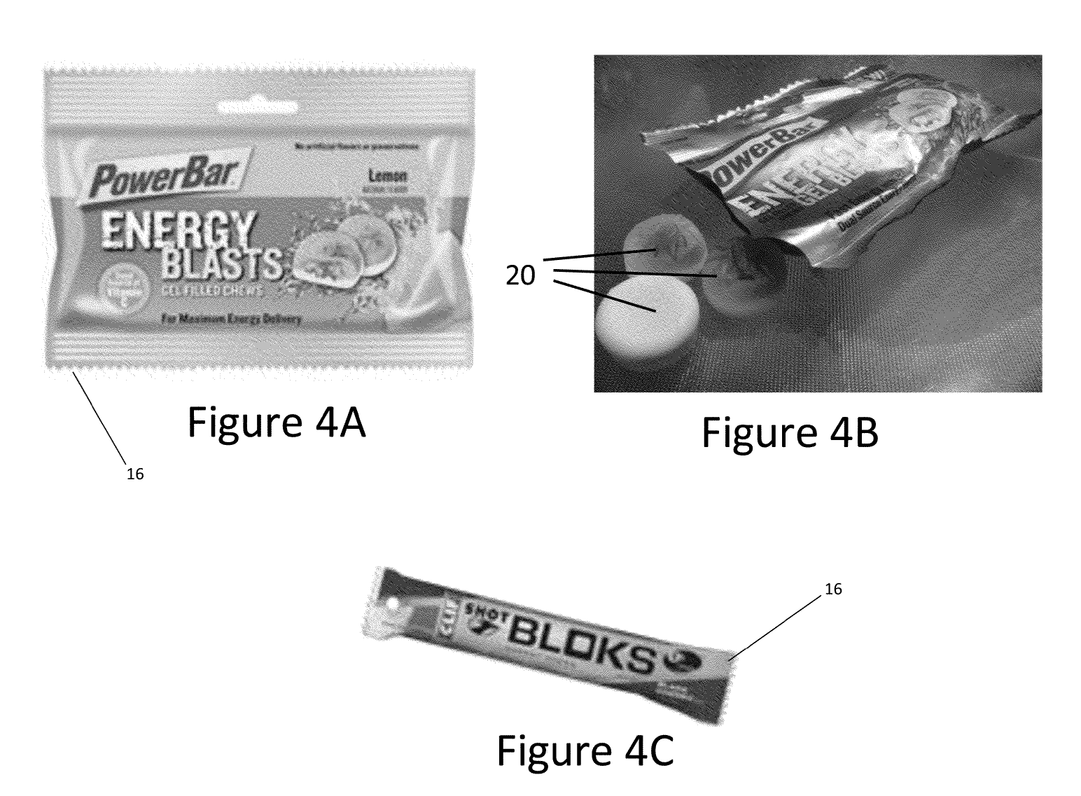

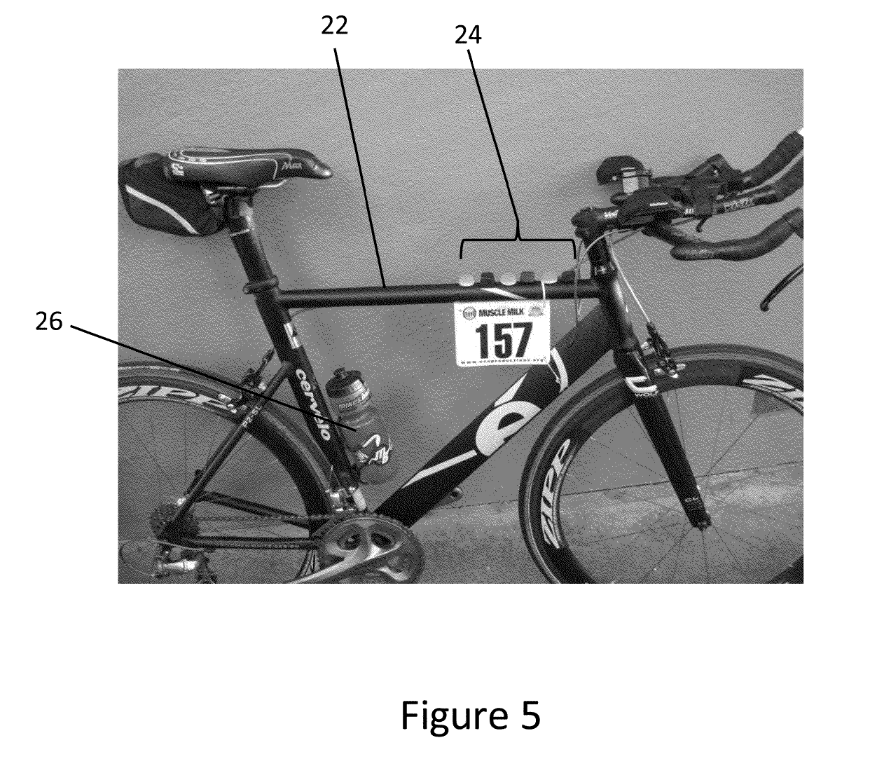

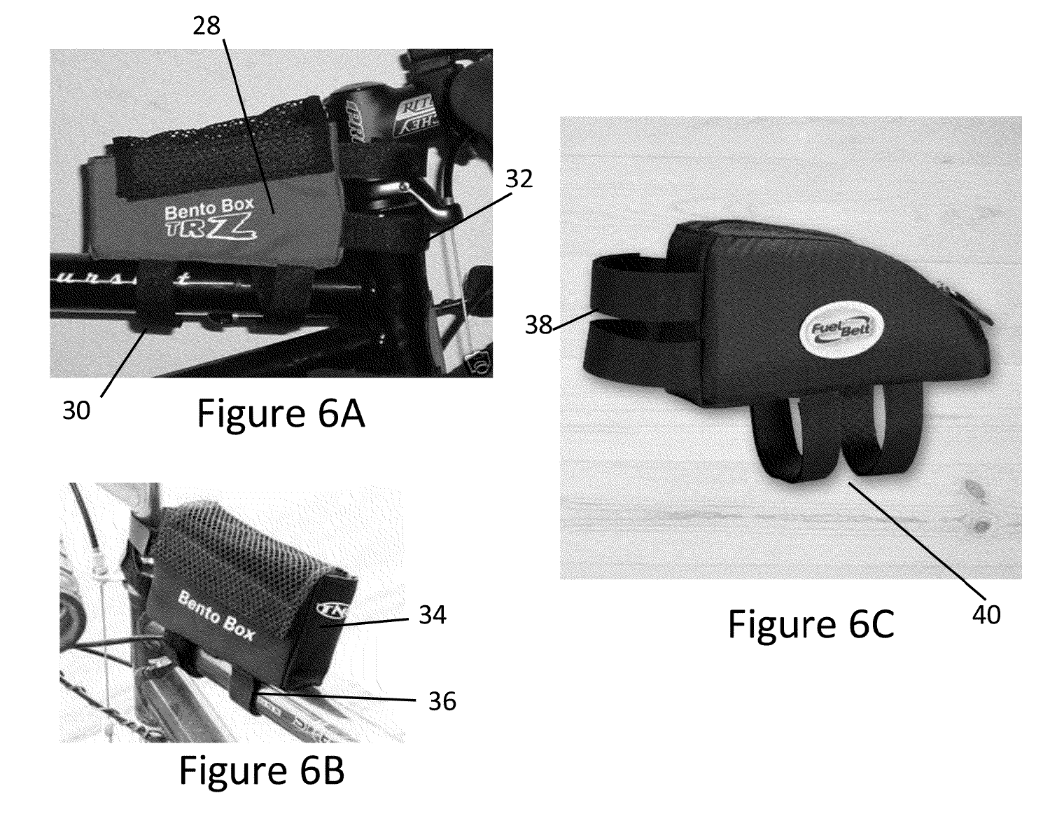

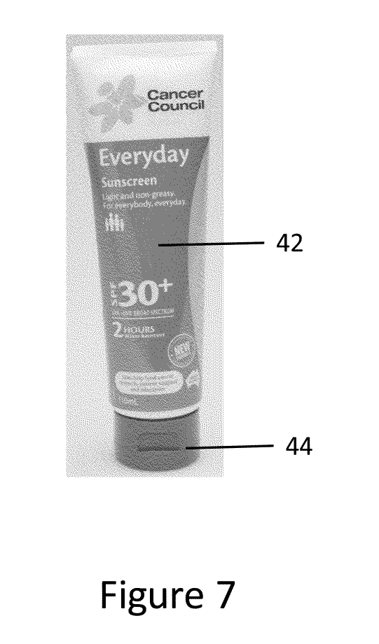

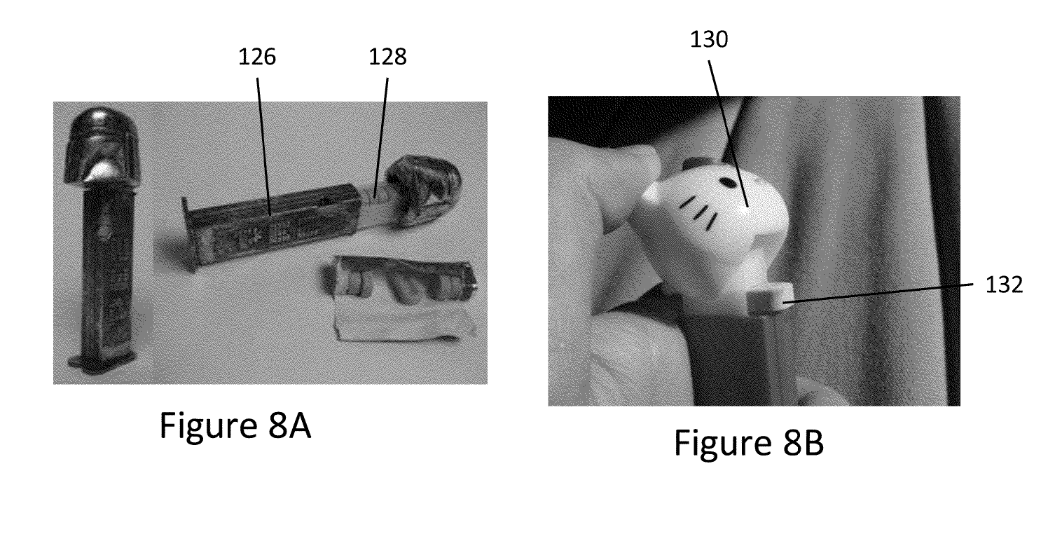

### SUMMARY

One embodiment is directed to an apparatus for assisting a bicycle-riding athlete with one-handed-operation consumables consumption, comprising: a housing coupled to a frame of a bicycle that may be ridden by the athlete; a revolving element rotatably coupled to the housing, the revolving element defining a plurality of included volumes, each of which may be at least partially filled with one or more consumable food elements; wherein the housing comprises a revolving element access port providing partial access to manually advance a rotational orientation of the revolving element relative to the housing such that a next rotationally successive included volume may be accessed through the access port to provide access to the one or more consumable food elements which may reside in such included volume. The housing may be fixedly coupled to the frame of the bicycle. The housing may be removably coupled to the frame of the bicycle. The housing may be removably coupled to the frame of the bicycle with a flexible strap element. The housing may comprise a saddle-shaped surface configured to interface with a tubular outer surface of the frame of the bicycle. The housing may comprise a polymeric material. The revolving element may define three, four, five, six, seven, or more included volumes. The revolving element may be rotatably coupled to the housing with an indexing interface configured to facilitate controlled rotation of the revolving element to one or more predetermined rotational orientations relative to the housing. The indexing interface may be configured to facilitate controlled rotation to one rotation orientation destination selected to maximally expose each of the included volumes. The indexing interface may comprise a detent configuration comprising a plurality of protruding surface elements. The indexing interface may comprise a detent configuration comprising a plurality of recessed surface elements. The revolving element access port may be configured to be in a gravity down orientation such that the one or more consumable food elements which may reside in the next rotationally successive included volume will drop down through the access port with the assistance of gravity where they may be manually captured with a hand when the revolving element is rotated into an orientation wherein the access port provides access to such next rotationally successive included volume. The revolving element may be substantially cylindrical. The revolving element may have an outer diameter of about 2 inches or less. The revolving element may have a cylindrical length of about 2 inches or less. The revolving element and housing may be configured such that the revolving element may be rotationally advanced to expose the next rotationally successive included volume to the access port by the same hand which may be positioned to capture any contents of the next rotationally successive included volume.

### DETAILED DESCRIPTION

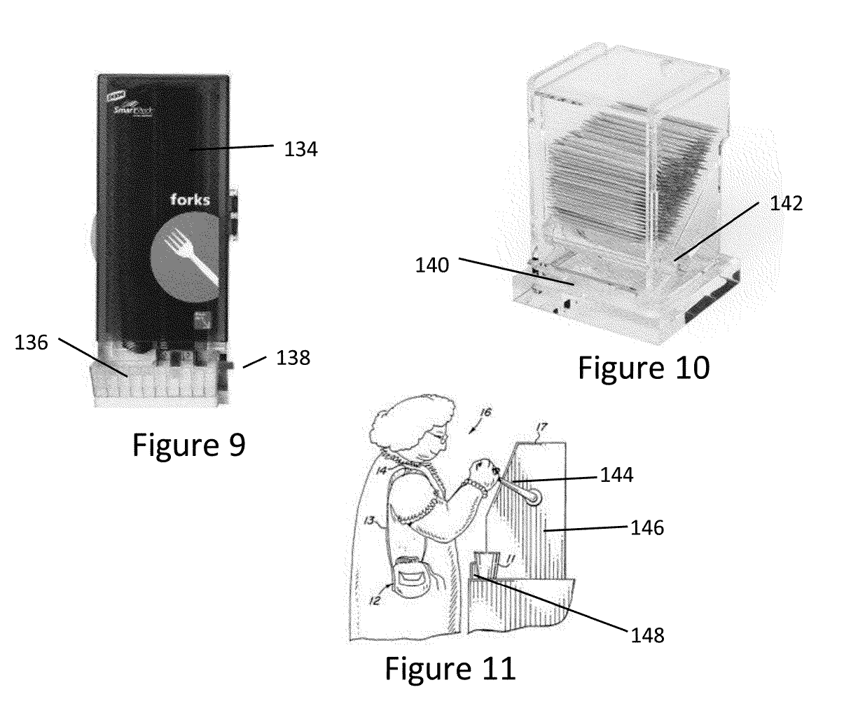

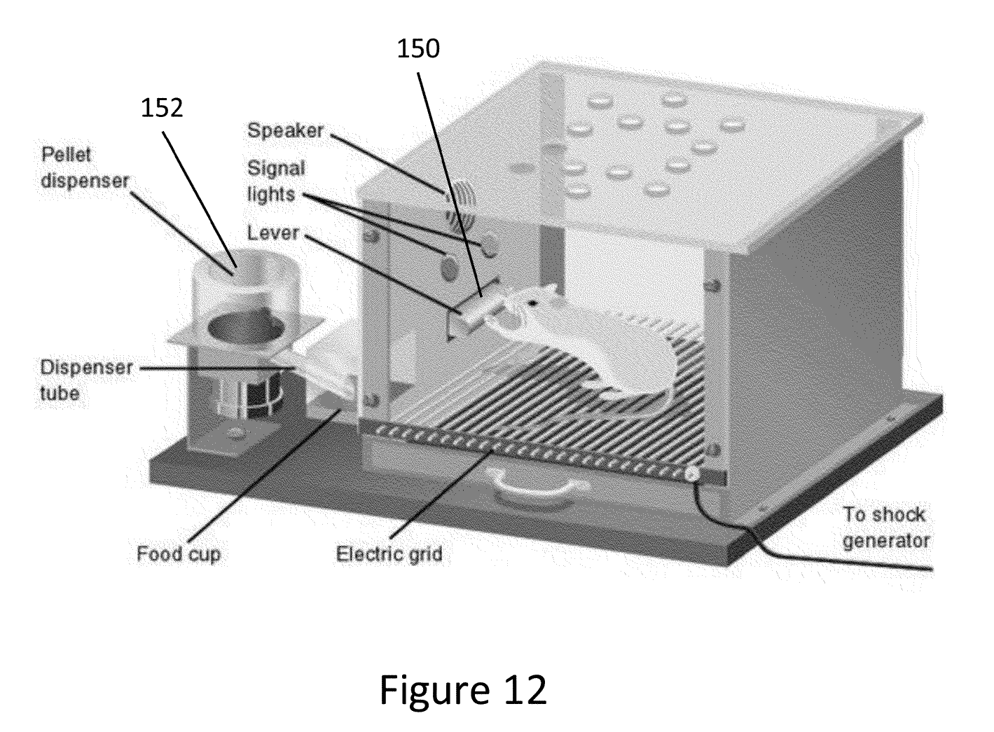

In accordance with the present invention, solid food and liquid sunblock containers and one-hand-operation dispensing devices may be coupled to a bicycle in various specialized configurations that allow the cyclist to use them during a race without changing riding position or slowing down. Referring to FIGS. 9A-B, a cyclist (66, 68, 70) in a race spends most of his/her time with his/her hands grasping the far-forward handlebars, often called “aerobars” in certain events such as triathlons, with thumbs and fingers almost touching (64,70) in a position such that they could squeeze a pump apparatus if it were positioned toward the front of the aerobars.

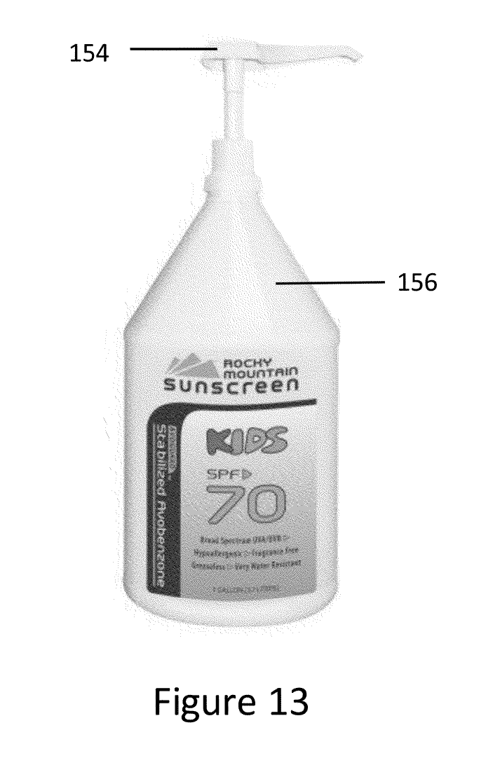

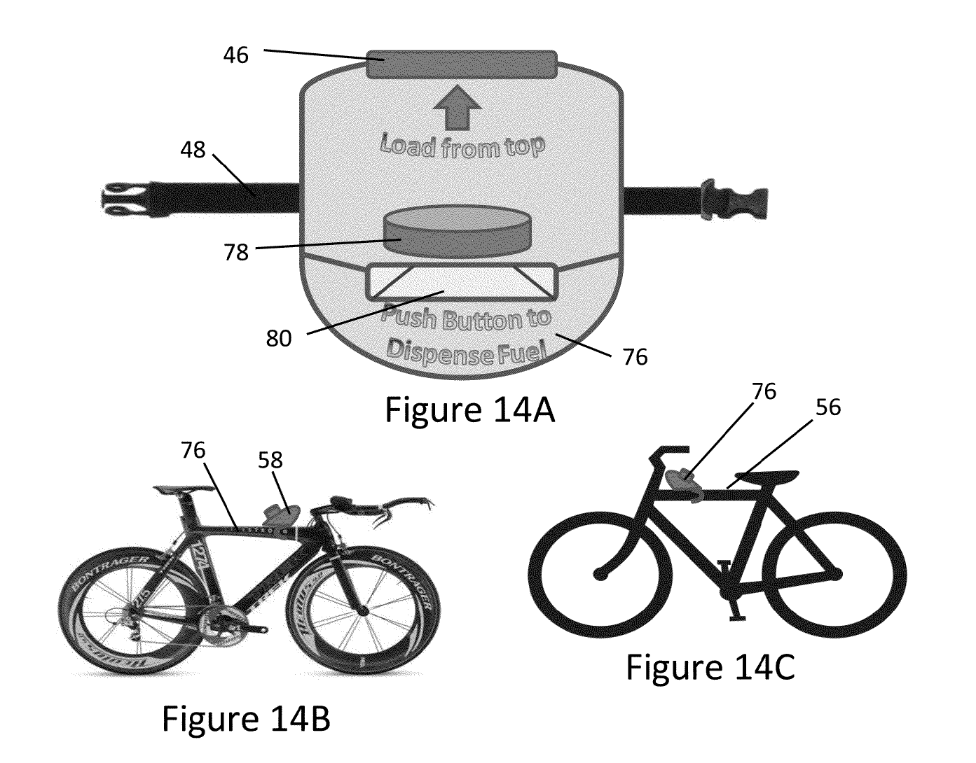

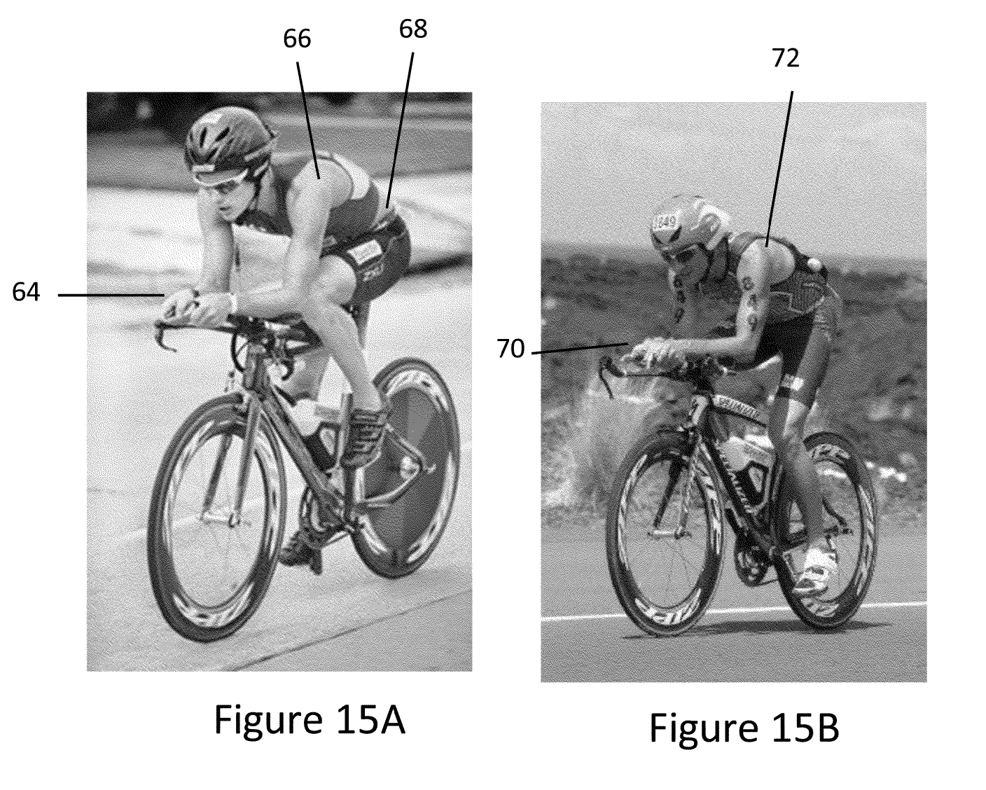

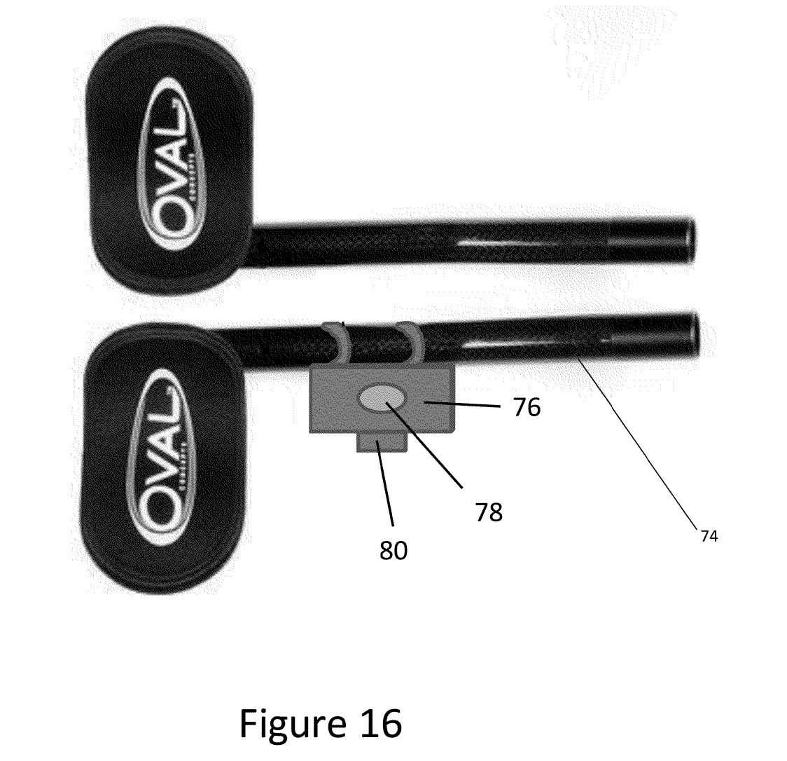

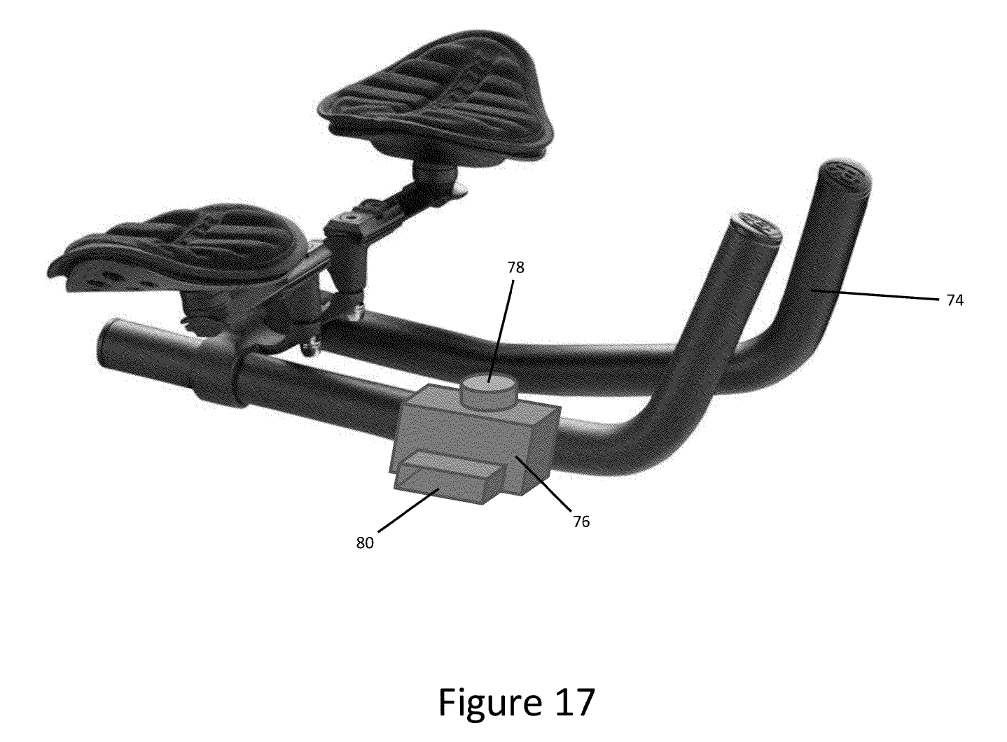

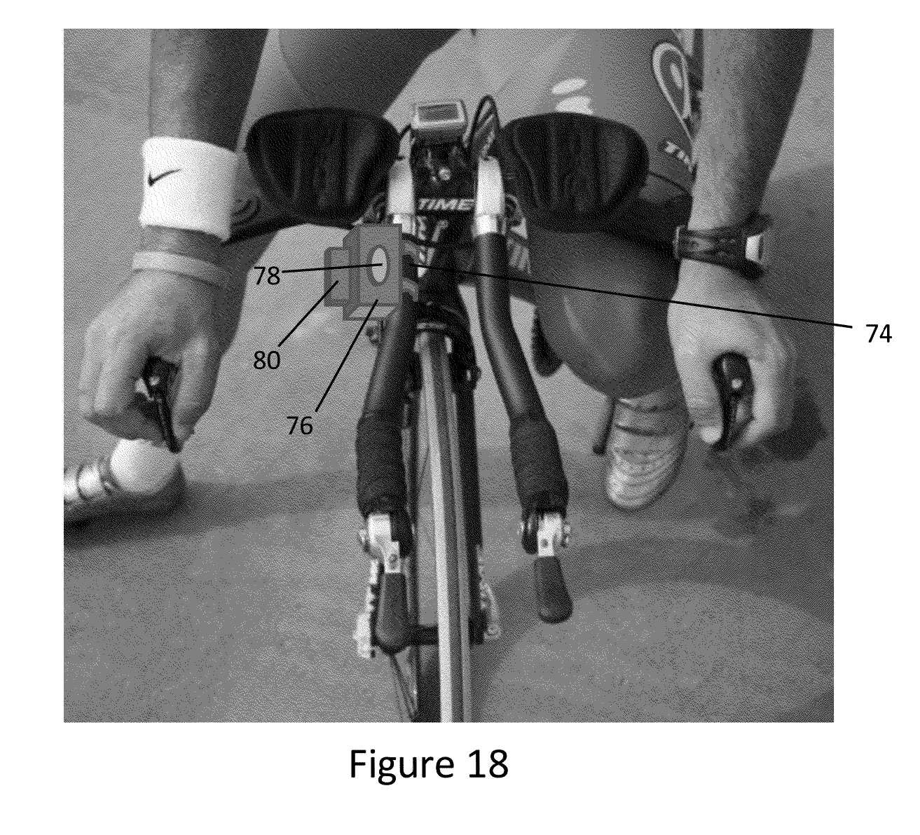

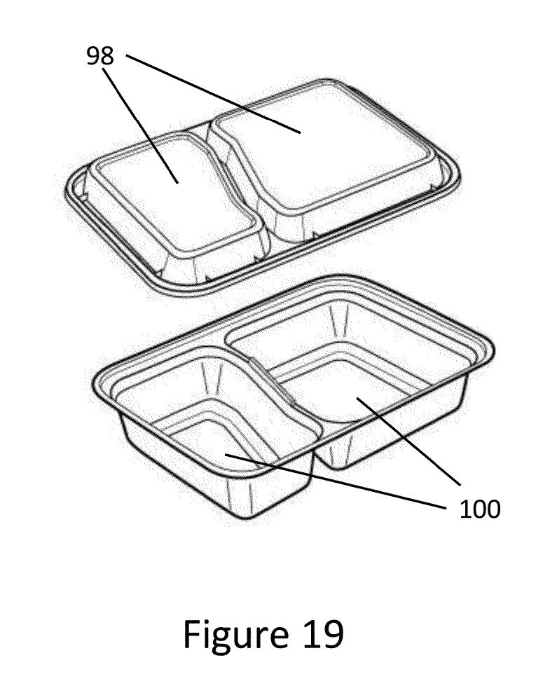

For example, referring to FIGS. 16-18, in one embodiment, a one-hand-operable food-dispensing container (76) attached to the side of one aerobar (74) could allow the cyclist to dispense a piece of an energy bar in a way that is safer and more hygienic than sticking the energy bar to his/her bicycle frame. The cyclist could, with the thumb of one hand, depress the food-dispensing button (78), which would trigger a single piece of solid food to be released from the food container (76) into the dispensing tray (80) over which the palm of the same hand would already be positioned, ready to palm the food item and lift it to the cyclist's mouth, all without the cyclist having to move his/her other hand. Regardless of the location on the bicycle—whether the container (76) is strapped to a bicycle's horizontal top tube (56) with a rubber or elastic strap or Velcro straps (48), as in FIGS. 14B and 14C (FIG. 14A depicts a magnified view for illustration purposes) or attached to the side of the aerobars (FIGS. 16-18)—the dispensing mechanism could allow the cyclist to operate it very efficiently. In the embodiment of FIG. 14A, food elements may be conveniently loaded through a loading port (46). Referring to FIG. 19, a deluxe version could feature a multi-compartment tray (100) to store and dispense different kinds of energy foods similar to the way multi-compartment Tupperware® containers (FIG. 13) sort food items into neat compartments; a lid (98) may be removably coupled to the tray (100).

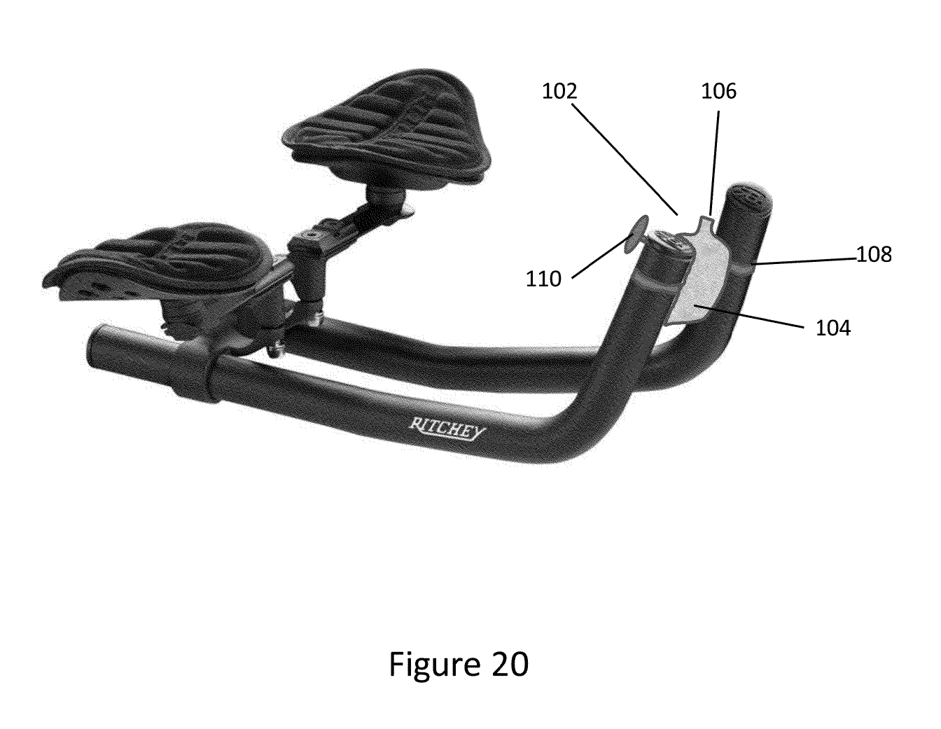

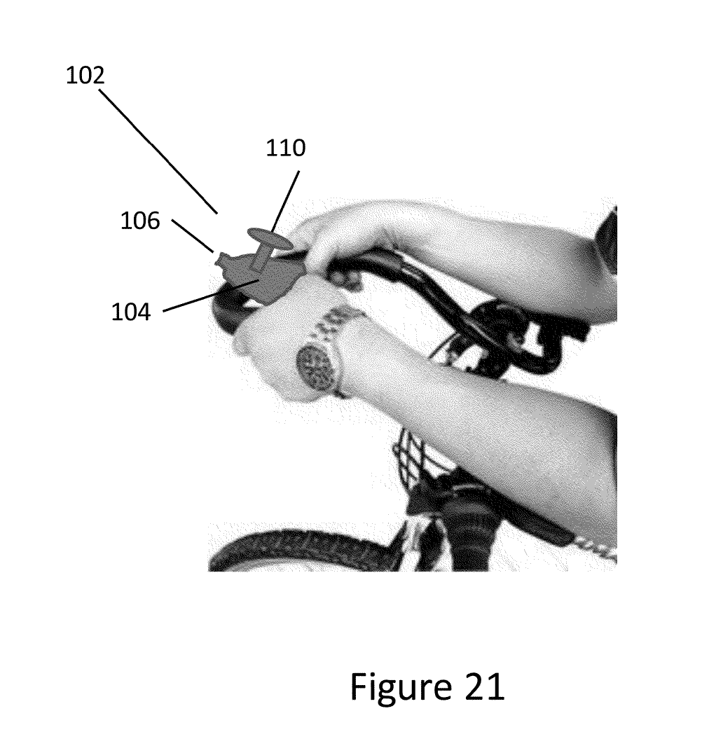

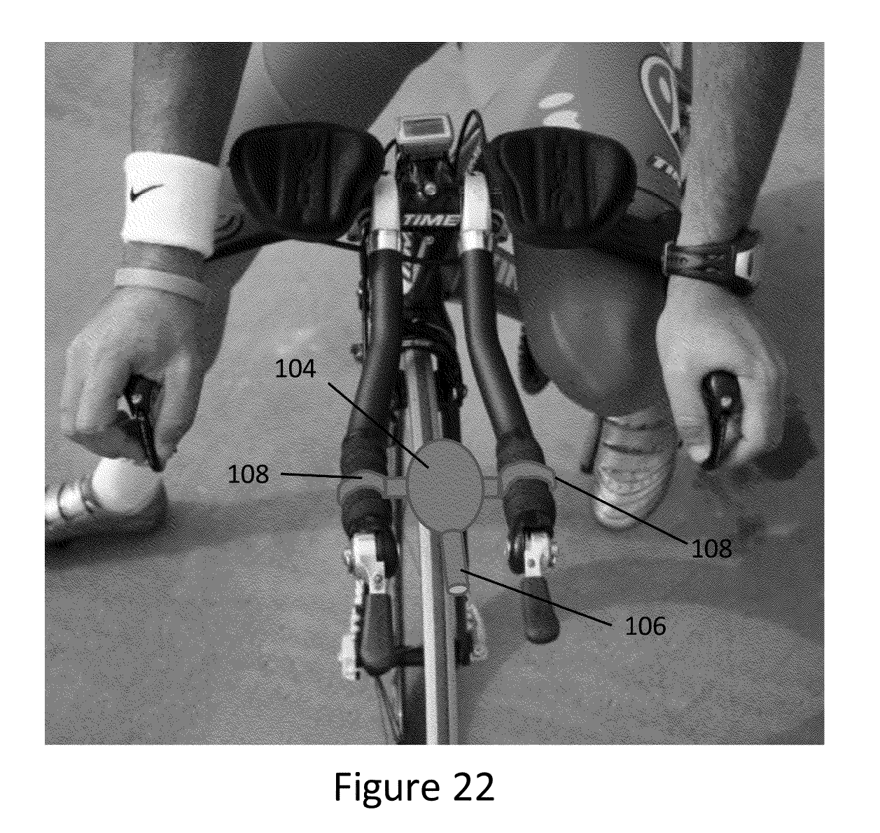

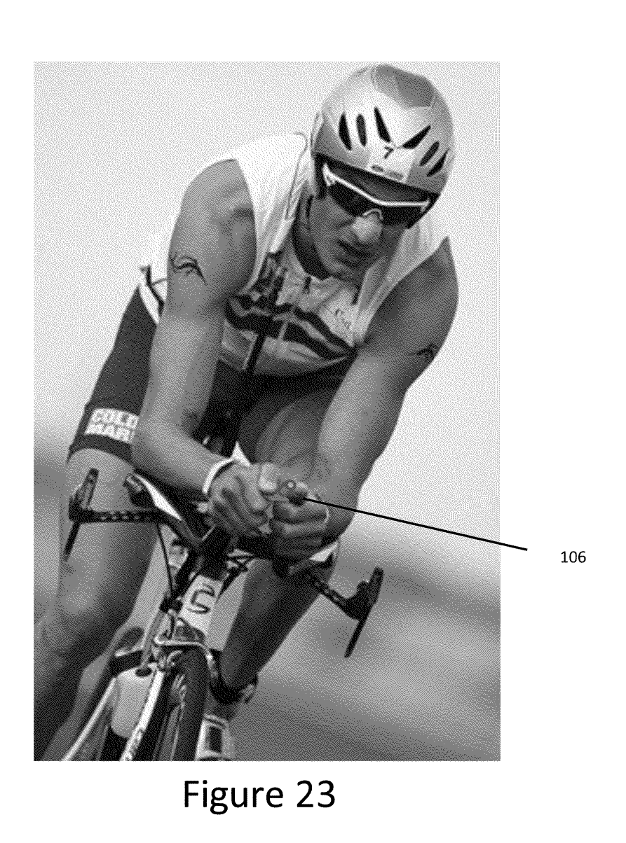

Referring to FIGS. 20-23, in another embodiment, a one-hand-operable sunblock-dispensing system (102) coupled (via a coupling member, 108) to the front of the cyclist's aerobars (for example, in between the two aerobars, as shown) could allow the cyclist to controllably pump an aliquot of sunblock from a reservoir or container (104) into the palm of the same hand or nearby contralateral hand through an output or exit port or chute (106). In one one-handed operation embodiment, the thumb and palm of the same hand could be used to control the dispensing. For example, the thumb may be utilized to controllably depress a plunger or other mechanical interface (110) operatively coupled to the dispensing system (102) while the palm is positioned over the exit chute of the sunblock dispenser to receive the dispensed material. In another embodiment, the reservoir (104) may comprise a malleable material configured to allow the operator to manually squeeze the material from the reservoir (104) out the output port (106). The cyclist may then easily apply sunblock to the exposed parts of his/her face and upper body with the hand that operated the pump and received the sunblock, while the other hand remains in racing position on the aerobar, allowing the cyclist to keep his/her head low and maintain cycling speed, as shown FIG. 23.

Preferably any attachment used will feature non-slip fastening interfaces or materials to prevent relative motion between device housing and bicycle frame or handlebars while the athlete is engaged in the event and/or trying to operate the device.

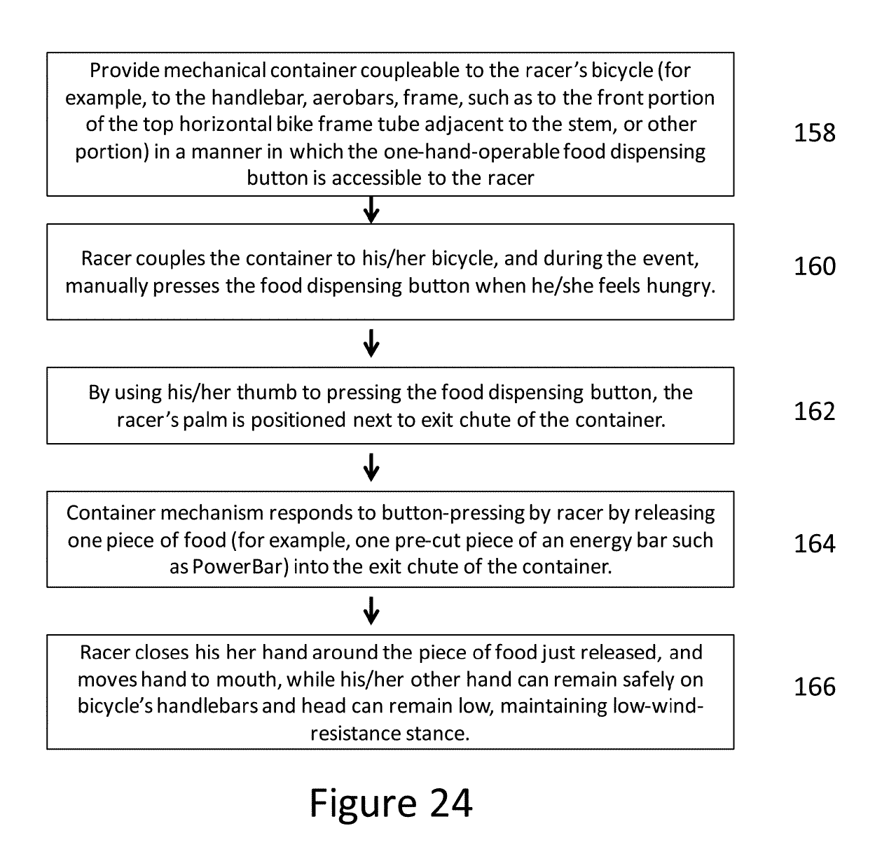

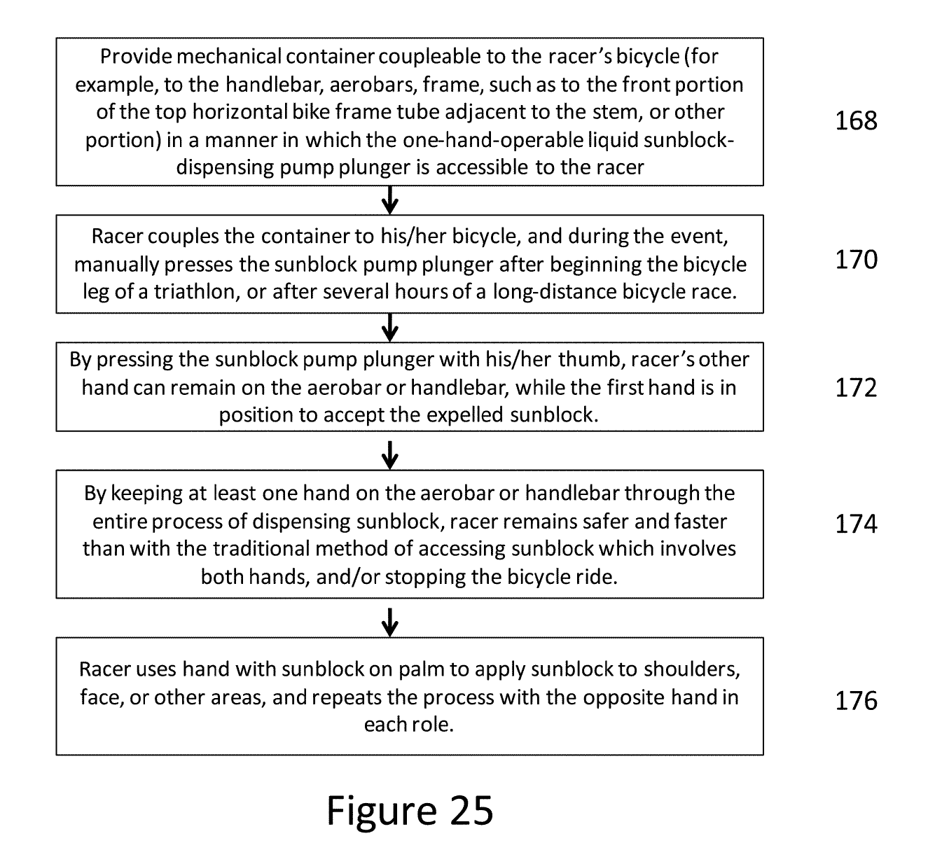

Referring to FIGS. 24 and 25, various configurations are illustrated in flowchart form.

Referring to FIG. 24, in one embodiment, a mechanical container coupleable to the racer's bicycle is provided in a manner in which the one-hand-operable food dispensing button is easily accessible to the racer while racing(158). The racer couples the container to his bicycle before the event, and during the event, manually presses the food dispensing button when he/she feels hungry (160). By using his/her thumb to pressing the food dispensing button, the racer's palm is positioned next to exit chute of the container (162). The container mechanism responds to the button-pressing by releasing one piece of food (for example, one pre-cut piece of an energy bar such as PowerBar) into the exit chute of the container (164). The racer then closes his/her hand around the piece of food just released, and lifts that hand to his/her mouth, while the other hand can remain safely on bicycle's handlebars and his/her head can remain low, maintaining a low-wind-resistance stance (166).

Referring to FIG. 25, an embodiment similar to that of FIG. 24 is illustrated, with the exception that the one-hand-operable bicycle-mounted consumables dispenser is for liquid sunblock during a race (168) instead of solid food during a race. The racer couples the container to his/her bicycle, and during the event, manually presses the sunblock pump plunger after beginning the bicycle leg of a triathlon, or after several hours of a long-distance bicycle race (170). By pressing the sunblock pump plunger with his/her thumb, the racer's other hand can remain on the aerobar or handlebar, while the first hand is in position to accept the expelled sunblock (172). By keeping at least one hand on the aerobar or handlebar through the entire process of dispensing sunblock, the racer remains safer and can keep racing faster he/she could with the traditional method of accessing sunblock which involves both hands, and/or stopping the bicycle ride (174). The racer then uses the hand with sunblock on its palm to apply sunblock to his/her shoulders, face, or other areas, and repeats the process with the opposite hand in each role (176).

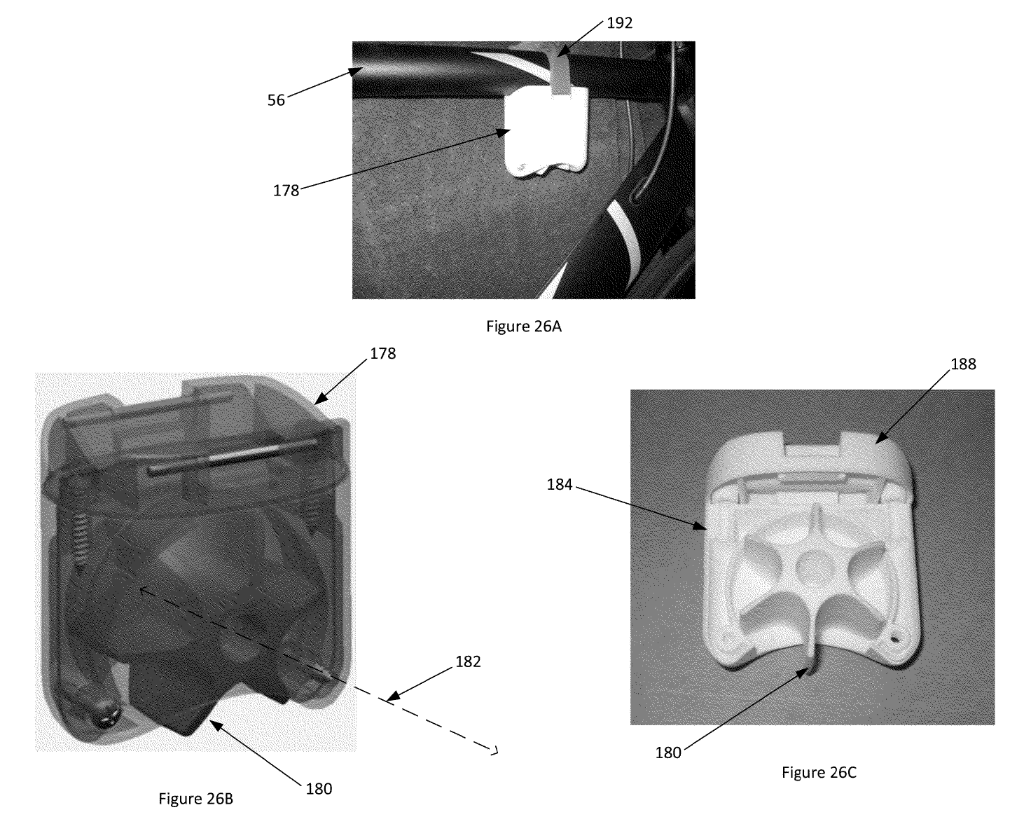

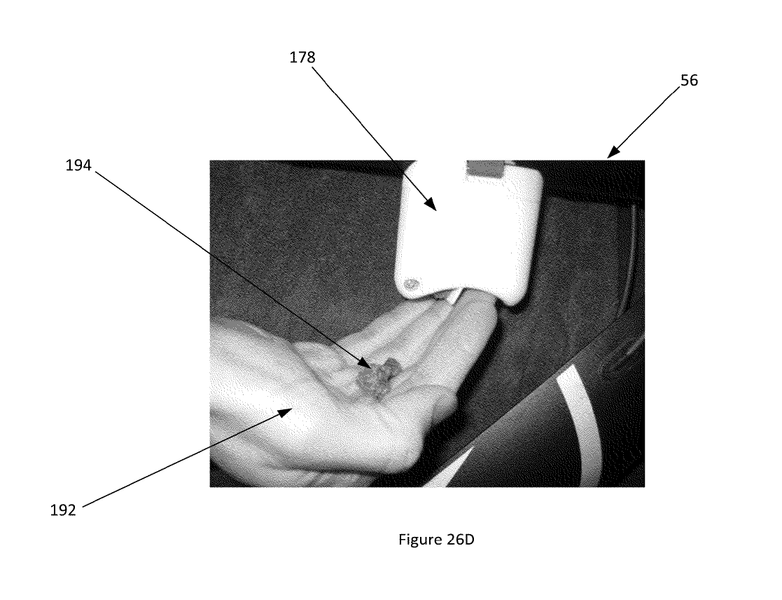

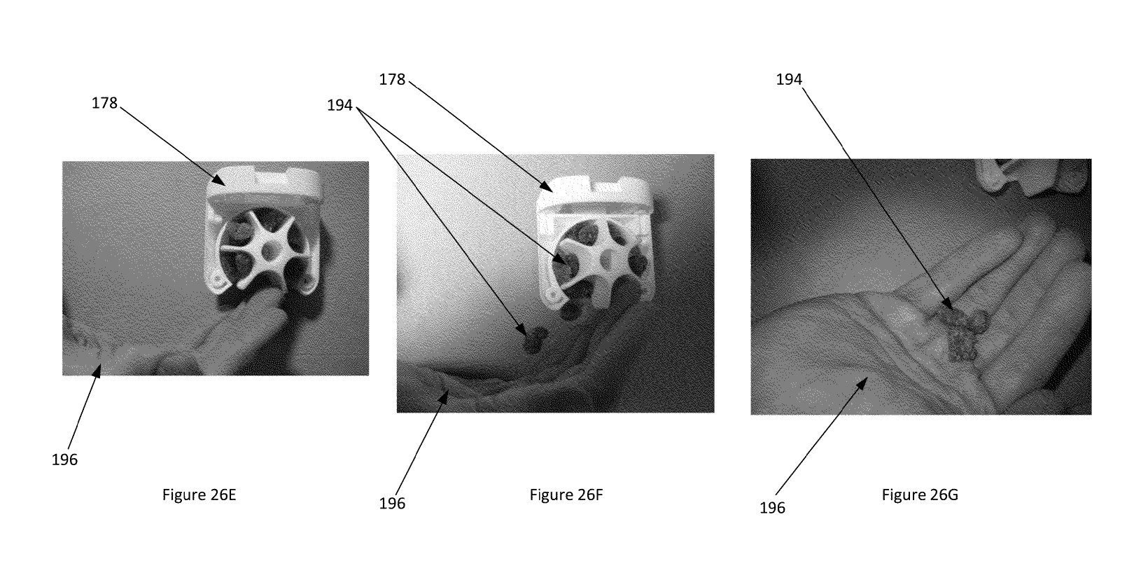

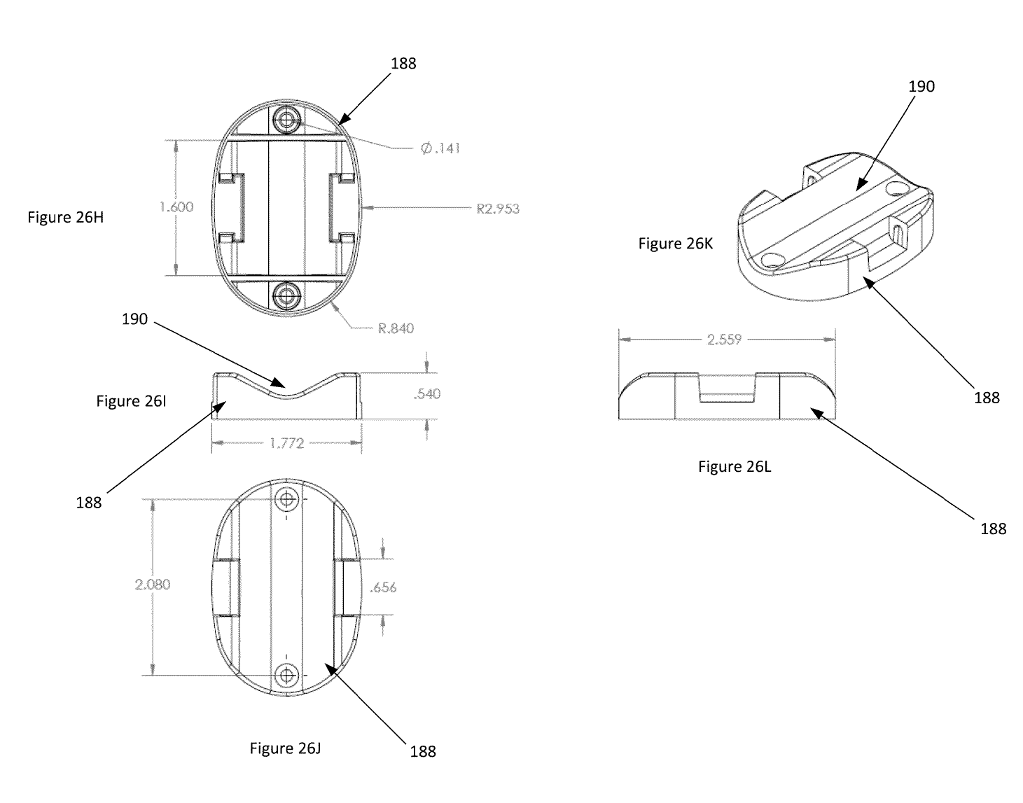

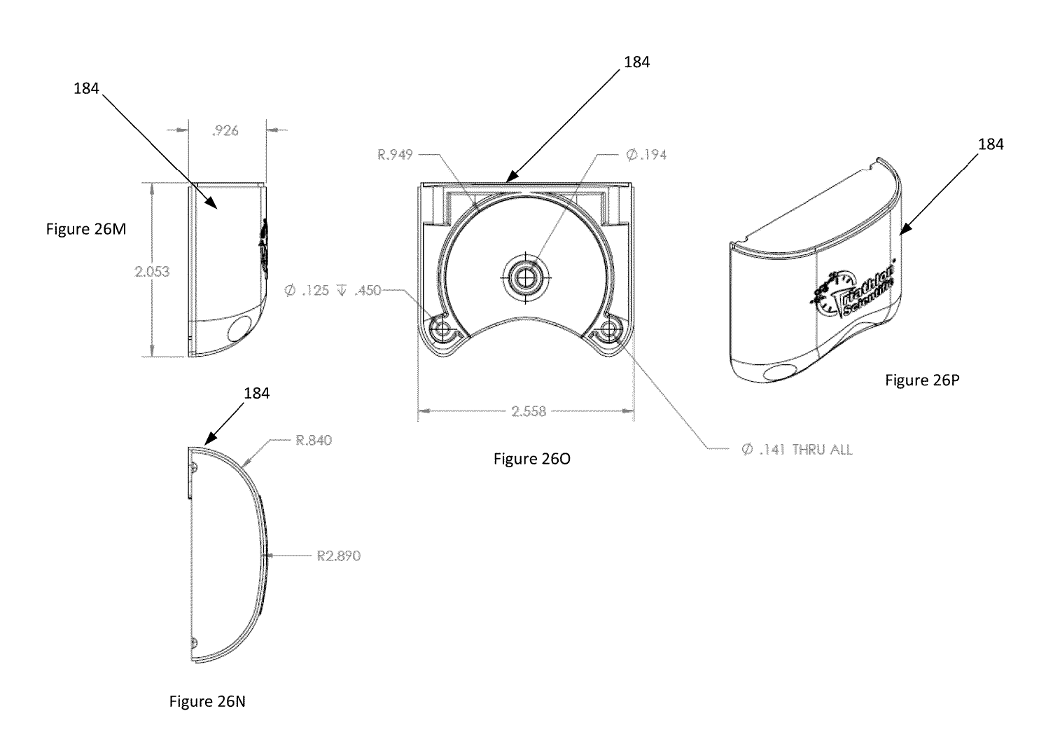

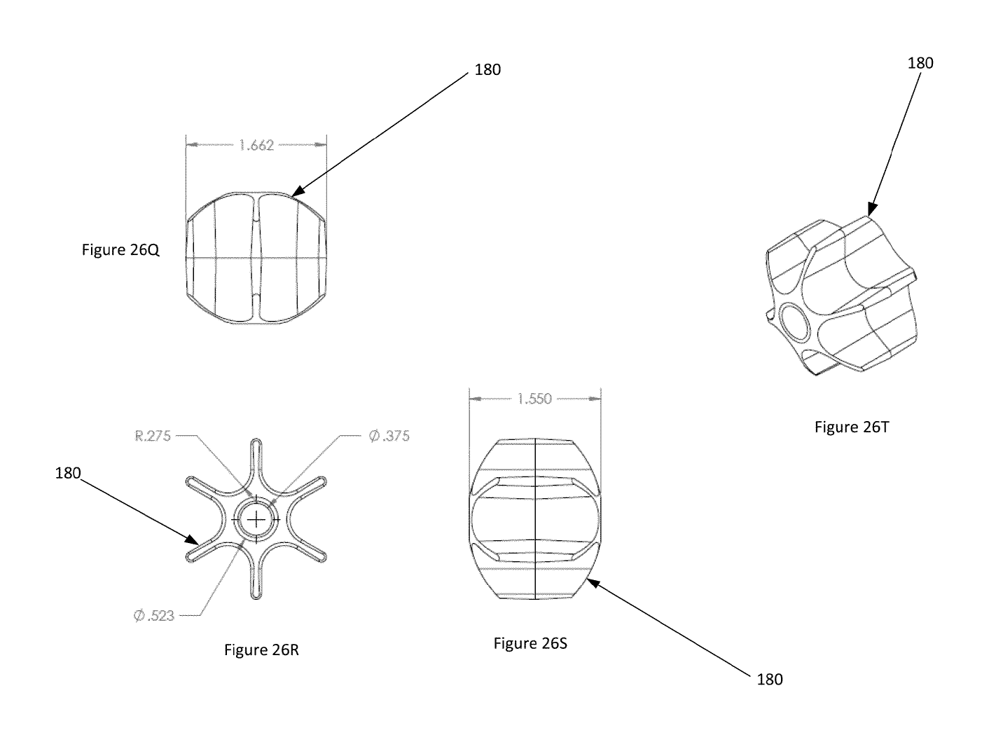

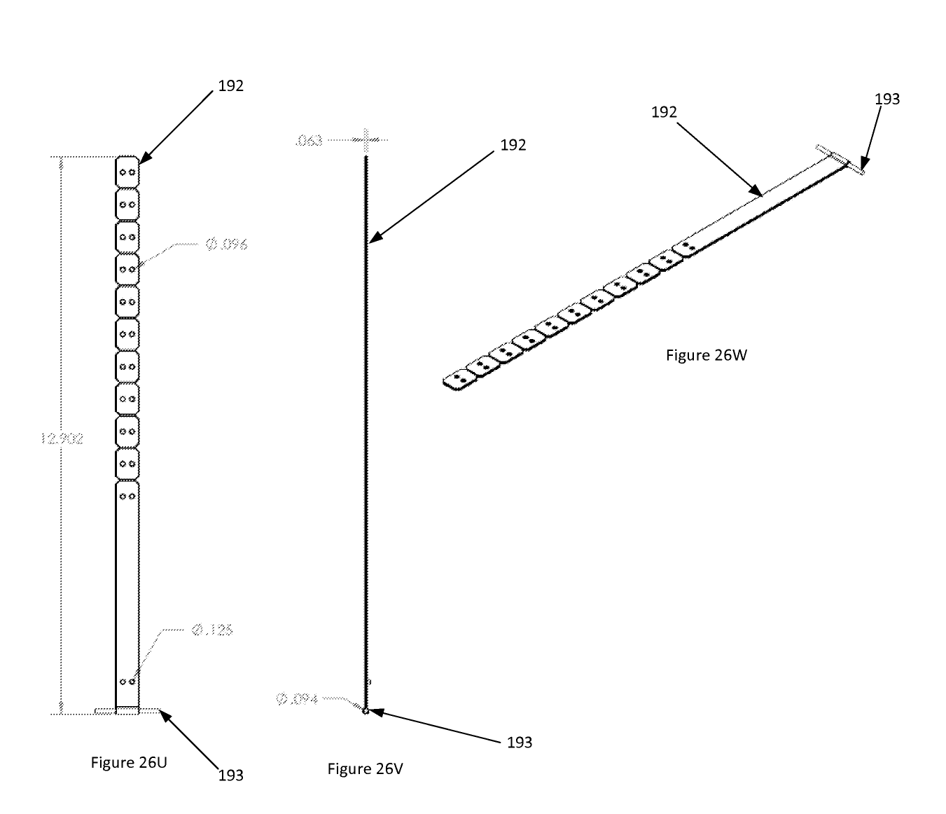

Referring to FIGS. 26A-26W, various aspects of one embodiment of a one-hand-operable food dispensing configuration (178) are depicted. Referring to FIG. 26A, the dispenser (178) may be removably coupled to a bike frame top tube (56) or other nearby structural element, such as a handlebar portion. Generally it is one objective of the design to place the food dispensing conveniently near and accessible to the athlete, as well as in an aerodynamic position—and thus the depicted mounting configuration is desirable. A strap coupling element (192), such as one comprising an elastomeric material, leather, Velcro, nylon, or the like, may be used to couple the dispenser (178) to the frame. In another embodiment the housing may be fixedly coupled to a bicycle frame or handlebar using a set screw or other clamping configuration. FIG. 26B shows a partially transparent orthogonal view to illustrate the position of a rotatably movable member (180) within the dispenser (178) which may be configured to rotate about an axis (182) as shown. FIG. 26C shows a partially assembled view to better illustrate the rotatably movable member (180) relative to the side housing portion (184) and top housing portion (188). The depicted embodiment of the rotatable member, or “revolving element”, (180) defines six included volumes, each of which may be at least partially filled with one or more consumable food elements. Other embodiments may feature revolving elements (180) that feature two, three, four, five, seven, eight, nine, or more included volumes.

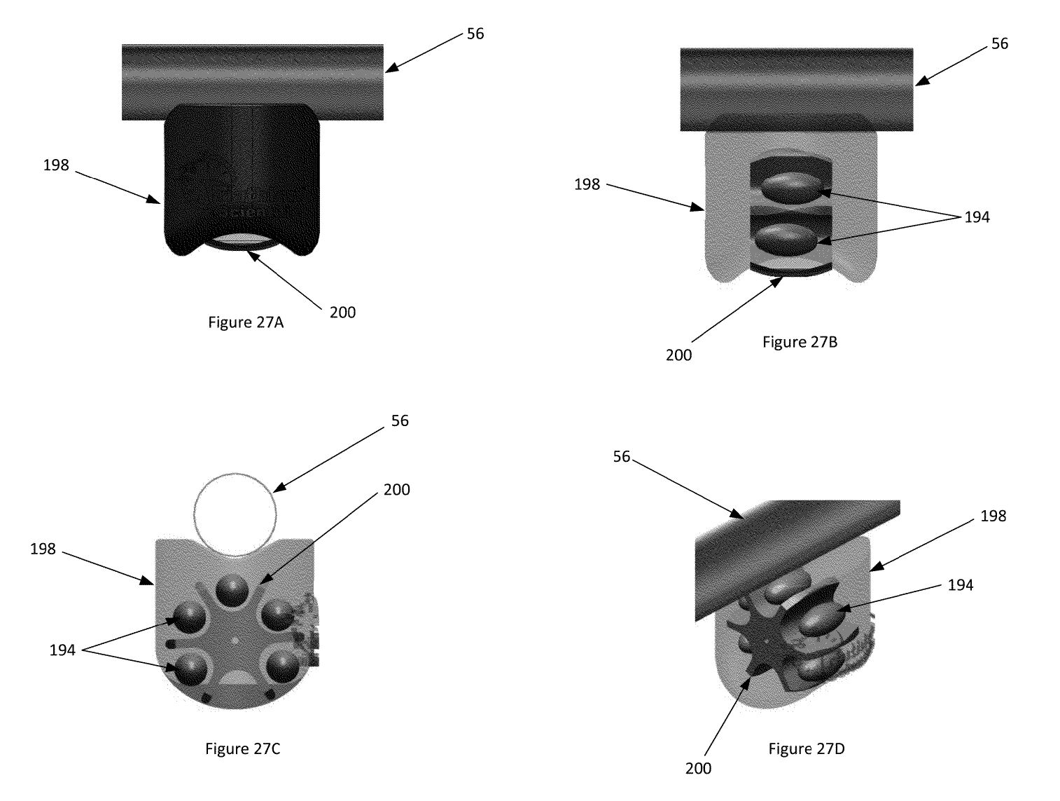

Referring to FIG. 26D, in operation, an athlete operating a bicycle may use his hand (192) to rotatably advance the rotatable member relative to the housing to dispense food elements (194) out of the access port defined through the bottom of the housing, through which the included volumes may be accessed (i.e., until each included volume is rotationally advanced around to a position at which it is aligned with the access port, the included volume is essentially closed; upon alignment of a given included volume with the access port, which preferably is in a gravity-down configuration, such included volume becomes accessible through the access port; with the access port gravity down configuration, preferably the food elements contained in such included volume will fall through the access port and into the operator's hand as shown in FIG. 26D, wherein one-handed operation is demonstrated with the same hand advancing the revolving element and capturing the consumables as they fall through the access port of the housing). The housing and revolving element may comprise lightweight polymeric materials. Further details of such configuration are illustrated in FIGS. 26E-26W. Referring to FIGS. 26E-26G, a sequence of dispensing activity with a hand and a partially cutaway food dispenser (178) are depicted to show that the athlete may use his or her hand (196) to rotationally advance (i.e., rotate) the rotatable member (180) relative to the rest of the device (178) and obtain free access to one or more food elements (194) which may be readily consumed with the same hand (196) that reached down to manipulate the device (178). In other words, this configuration is designed for one-handed use—to enable the operator to focus on and conduct other activities, such as steering a bicycle with his other hand. FIGS. 26H-26L depict various views of a top housing portion (188) which features a saddle-like surface (190) designed to engage a substantially rounded tube, such as a top tube of a bicycle frame. FIGS. 26M-26P illustrate various views of a side housing member (184). Featured dimensions of the depicted embodiment are in inches (in FIGS. 26H-26W). FIGS. 26Q-26T illustrate various views of a suitable rotatable member (180). FIGS. 26U-26W illustrate various views of a strap (192) coupling member as well as a coupling pin member (193), which may be utilized together to removably couple the dispenser (178) to a structure such as a bike frame. FIGS. 27A-27D illustrate another embodiment of a dispenser (198) with rotatable member (200), this rotatable member (200) being rotatably coupled to the remainder of the dispenser configuration (198) such that the rotatable member (200) rotates about an axis of rotation that is substantially parallel to that of the coupled bicycle top tube (56). The rotatable member (200) may be manipulated with one hand to provide controlled one-handed access to food elements (194) in a manner akin to the embodiment of FIGS. 26A-26W, with the exception that the rotational orientation is different. The dispenser embodiments of FIGS. 26A-26W and 27A-27D (178, 198) may be loaded with food elements by holding such devices (178, 198) upside down and inserting food elements upon exposure to each sequential empty cavity. The rotational coupling interface between the housing portions and the rotatable element of such configurations may feature detent/ball interfacing to bias the rotatable element to stop in certain rotational positions but to freely rotate in between such positions. In other words, the revolving element may be rotatably coupled to the housing with an indexing interface configured to facilitate controlled rotation of the revolving element to one or more predetermined rotational orientations relative to the housing. The predetermined orientations may be selected to maximally expose each of the included volumes to the access port of the housing. A detent configuration may comprise a plurality of protruding and/or recessed surface interface elements upon either of the rotatably coupled structures. The revolving element, as shown, for example, in FIGS. 26Q-26S, may comprise a substantially cylindrical outer shape which may be less than about 2 inches long and less than about 2 inches in diameter. In other embodiments, either of the configurations of FIGS. 26A-26W and 27A-27D (178, 198) may feature lightweight electric motors, portable power supplies (such as one or more batteries), and electronic advancement controls (such as a button that may be depressed to electromechanically advance the rotatable member to the next position). Preferably such advancement controls are positioned to facilitate one-handed operation (i.e., activating advancement and containment/grasp of the dispensed food elements with one hand, leaving the other hand to do something else, such as stabilize a bicycle)—such as in a configuration wherein a small pushbutton is mounted near the bottom and/or side of the device housing where the food is dispensed.

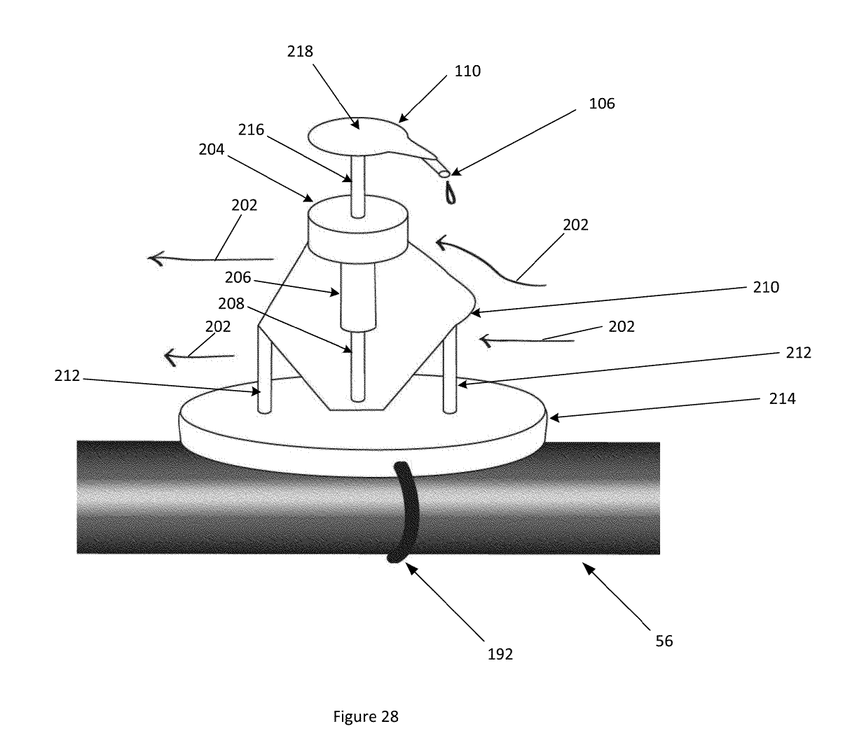

Referring to FIG. 28, another embodiment is depicted wherein a consumable liquid material such as sunblock may be controllably dispensed by a cyclist athlete using one hand. As shown in FIG. 28, a base structure (214) may be removably coupled to a portion of a bicycle, such as a bicycle frame top tube (56), using a strap (192). A surface of the base structure (214) immediately adjacent the bicycle frame tube (56) may have a saddle-shaped geometry similar to that depicted in FIG. 26L (element 190) to promote temporary fixation against the tube (56) using the strap (192). A fluid material housing (210) configured to contain the sunblock or other fluid preferably is fixedly coupled to the base structure (214); the depicted variation features two relatively thin and aerodynamic coupling members or struts (212) for coupling the housing (210) to the base structure (214). Preferably the outer geometry of the housing (210) is aerodynamically shaped such that airflow (202) due to bicycle travel may easily pass by the housing (210); further, preferably the housing is shaped such that the gravity bottom of the housing is configured to gather available fluid contained within the housing into a relatively small volume such that a nearby take-up-tube (208) may easily vacuum up the fluid, even when the available fluid has nearly completely been consumed. In one embodiment, an inner volume for consumable fluid that is defined by the geometry of the housing (210) is only large enough to contain sufficient fluid for a racer/athlete to complete one race. In other words, the consumable assembly may be configured to be small, light, aerodynamic, and generally of minimal capacity to assist the athlete in completing one event before replenishing of the reservoir/housing with additional sunblock or other consumable fluid. The embodiment depicted in FIG. 28 features a mechanical interface (110) that comprises a plunger push surface (218) coupled to a plunger shaft member (216), which is movably coupled through a housing interface cap member (204) which may be threadably coupled to an upper surface of the housing (210). The cap member (204) and plunger shaft member (216) may be operatively coupled to a piston/cylinder assembly (206) that is configured to draw available fluid up through the uptake tube (208), through a channel defined through the plunger shaft member (216), and out through the output port (106) as shown. The assembly is configured for one-handed operation by an athlete operating a bicycle; the athlete may reach down, press the plunger push surface with one portion of his hand, and capture the expelled fluid out of the output port (106) with the fingers of the same hand.

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

The invention includes methods that may be performed using the subject systems and devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. An apparatus for assisting a bicycle-riding athlete with one-handed-operation consumables consumption, comprising:
a. a housing coupled to a frame of a bicycle that may be ridden by the athlete;
b. a revolving element rotatably coupled to the housing, the revolving element defining a plurality of included volumes, each of which may be at least partially filled with one or more consumable food elements;
wherein the housing comprises a revolving element access port providing partial access to manually advance a rotational orientation of the revolving element relative to the housing such that a next rotationally successive included volume may be accessed through the access port to provide access to the one or more consumable food elements which may reside in such included volume.

2. The apparatus of claim 1, wherein the housing is fixedly coupled to the frame of the bicycle.

3. The apparatus of claim 1, wherein the housing is removably coupled to the frame of the bicycle.

4. The apparatus of claim 3, wherein the housing is removably coupled to the frame of the bicycle with a flexible strap element.

5. The apparatus of claim 1, wherein the housing comprises a saddle-shaped surface configured to interface with a tubular outer surface of the frame of the bicycle.

6. The apparatus of claim 1, wherein the housing comprises a polymeric material.

7. The apparatus of claim 1, wherein the revolving element defines three included volumes.

8. The apparatus of claim 1, wherein the revolving element defines four included volumes.

9. The apparatus of claim 1, wherein the revolving element defines five included volumes.

10. The apparatus of claim 1, wherein the revolving element defines six included volumes.

11. The apparatus of claim 1, wherein the revolving element defines seven included volumes.

12. The apparatus of claim 1, wherein the revolving element is rotatably coupled to the housing with an indexing interface configured to facilitate controlled rotation of the revolving element to one or more predetermined rotational orientations relative to the housing.

13. The apparatus of claim 12, wherein the indexing interface is configured to facilitate controlled rotation to one rotation orientation destination selected to maximally expose each of the included volumes.

14. The apparatus of claim 12, wherein the indexing interface comprises a detent configuration comprising a plurality of protruding surface elements.

15. The apparatus of claim 12, wherein the indexing interface comprises a detent configuration comprising a plurality of recessed surface elements.

16. The apparatus of claim 1, wherein the revolving element access port is configured to be in a gravity down orientation such that the one or more consumable food elements which may reside in the next rotationally successive included volume will drop down through the access port with the assistance of gravity where they may be manually captured with a hand when the revolving element is rotated into an orientation wherein the access port provides access to such next rotationally successive included volume.

17. The apparatus of claim 1, wherein the revolving element is substantially cylindrical.

18. The apparatus of claim 1, wherein the revolving element has an outer diameter of about 2 inches or less.

19. The apparatus of claim 17, wherein the revolving element has a cylindrical length of about 2 inches or less.

20. The apparatus of claim 16, wherein the revolving element and housing are configured such that the revolving element may be rotationally advanced to expose the next rotationally successive included volume to the access port by the same hand which may be positioned to capture any contents of the next rotationally successive included volume.
